(19) United States
(12) Patent Application Publication
(10) Pub. No.: US 2017/0217366 A1
(43) Pub. Date: Aug. 3, 2017

(54) COMPONENT FOR A VEHICLE INTERIOR

(71) Applicant: Shanghai Yanfeng Jinqiao Automotive Trim Systems Co., Ltd., Plymouth, MI (US)

(72) Inventors: Werner Kraemer, Luebbecke (DE); Norbert Truxa, Dusseldorf (DE)

(21) Appl. No.: 15/486,059

(22) Filed: Apr. 12, 2017

Related U.S. Application Data
(63) Continuation of application No. PCT/EP2015/074042, filed on Oct. 16, 2015.

(30) Foreign Application Priority Data
Oct. 16, 2014 (DE) 10 2014 221 080

(51) Int. Cl. B60Q 3/64; B60Q 3/80; B60Q 3/54; B60Q 3/233; B60Q 3/14; B60Q 3/217

(52) U.S. Cl. CPC B60Q 3/64; B60Q 3/14; B60Q 3/217; B60Q 3/54; B60Q 3/233; B60Q 3/80; B60Q 2500/10

(57) ABSTRACT

An interior component for a vehicle is disclosed. The interior component may be configured to include portions facing the passenger compartment of the vehicle that can be illuminated by a light source providing light. The interior component may comprise a panel having a first side facing the passenger compartment, and a fabric having optical fibers wrapped around an edge of the panel and along at least part of the first side. The optical fibers may be coupled to the light source and configured to transmit light through the fabric. The fabric may be configured to transmit the light by total internal reflection. The fabric may be configured illuminated portions on the first side of the panel where total internal reflection is prevented to allow the light to be emitted only at the illuminated portions. The fabric may be configured with different designs, patterns or shapes corresponding to the illuminated portions.

### CROSS REFERENCE TO RELATED APPLICATIONS

The present application is a continuation of International Application No. PCT/EP2015/074042 titled “COMPONENT FOR A VEHICLE INTERIOR” filed Oct. 16, 22015.

The present application claims priority from and the benefit of and incorporates by reference in entirety of the following applications: (a) International Application No. PCT/EP2015/074042 titled “COMPONENT FOR A VEHICLE INTERIOR” filed Oct. 16, 2015; (b) German Application No. 10 2014 221 080 titled “INNENAUSSTATTUNGSTEIL FUR KRAFTFAHRZEUGE” filed on Oct. 16, 2014.

### FIELD

The present invention relates to a component for a vehicle interior. The present invention also relates to a component providing an illuminated surface for a vehicle interior.

### BACKGROUND

It is well-known to provide vehicle interior trim parts and vehicle interior components throughout the cabin of a typical passenger vehicle. It is also well-known that the interior trim parts and components provide many of the surfaces directly facing and defining the interior, such that the look and feel of the vehicle interior is directly influenced by the interior trim parts. It is also well-known that the interior trim parts and components may also be used to conceal and protect functional components within the vehicle door(s), dashboard, center console, etc.

Although a wide variety of different materials, colors, and/or patterns are available for selection by a vehicle manufacturer or consumer, it would be advantageous to provide vehicle interior trim parts and vehicle interior components having an outer appearance which meets the demands for a high-end vehicle.

It is well-known that interior trim parts and components are used in motor vehicle passenger compartments as for example trim panels covering car body elements in the area of the doors. It is also well-known that interior trim components are also used as cladding in other areas of the vehicle's interior. It is also well-known that such interior trim fittings consist for example of various plastic materials, cloth materials or high-quality materials such as leather as well as combinations thereof.

It is well-known that interior trim fittings of this type frequently serve not only as just trim paneling for vehicle body elements or the like but also increasingly serve to attract the attention of consumers and enhance the overall appearance of the vehicle. As a result, a vehicle's interior trim is increasingly becoming an important distinctive feature and should create style and ambiance tailored to the car buyer's desires.

It would be advantageous to provide lighting solutions which integrate harmoniously into the design of the vehicle's interior. It would also be advantageous to provide the most unique lighting of the interior possible in the most easily realized way without excessive restructuring of the interior trim components so as to be able to create different customer-specific styles from a minimalist reduction to the essentials to emphasizing sportiness to creating an atmosphere of luxury. It would also be advantageous to do so based on the recognition that well-conceived and integrated lighting conveys a sense of comfort and produces a strong emotional connection to the vehicle. It would also be advantageous to improve safe driving at night by illuminating control elements, storage compartments or storage spaces.

It is well known to integrate area backlighting into interior trim fittings, particularly in the region of the instrument panel and the center console. It is also well-known that such backlighting does, however, have the disadvantage of only being adaptable to a customer's desires at considerable effort. It is moreover not generally possible for backlighting to achieve uniform illumination across the entire area.

It is well-known to provide light-emitting diodes that are integrated into the interior trim fittings. It is also well-known that this approach is unsuited to integrating large-area lighting solutions at the lowest possible expenditure.

It is known to provide optical fiber for interior lighting. This normally relates to optical fiber having a square surface area which is somewhat larger than the visible area of the interior trim fitting enabled by an aperture. The materials used are for example transparent PMMA (polymethyl methacrylate and/or Plexiglas) or polycarbonate. The light is coupled in through the sides of the optical fiber. Point light sources, usually along one or two opposite sides, feed the optical fiber. The light is transmitted within the optical fiber by total reflection (TIR). To selectively decouple light from the optical fiber, interference points are generated which inhibit the TIR condition.

It is well-known that personalized lighting of a vehicle interior have in particular the disadvantage that such lighting solutions can only be implemented in the vehicle interior at relatively high expenditure. It would be advantageous to provide lighting solutions that can be harmoniously integrated into a vehicle interior's design without additional installation space required for the components associated with the lighting solution.

It would also be advantageous to provide a method for manufacturing such interior parts and components in an easy and economical way.

### SUMMARY

The present invention relates to a component for a vehicle interior providing a passenger compartment configured to be illuminated by a light source providing light. The component may comprise (a) a panel comprising a first side configured to face the passenger compartment and a second side, (b) a fabric comprising optical fibers configured to transmit light provided by the light source within the optical fibers by total internal reflection, and (c) an interface configured to couple the light source to the fabric. The fabric may at least partially cover the first side of the panel. The fabric may be wrapped around at least an edge of the panel. At least a portion of the fabric covering the first side may be configured to be illuminated. The optical fibers may be configured to prevent total internal reflection to direct at least a portion of the light provided by the light source substantially perpendicular to the first side of the panel. The optical fibers may be configured to transmit light provided by the light source around the edge of the panel. The optical fibers may be sized and comprised of a material to allow the optical fibers to bend around the edge of the panel and transmit light provided by the light source. The component may comprise a reflective layer provided between the panel and the fabric; wherein the reflective layer is configured to reflect light away from the first side of the panel. The component may comprise a cover configured to transmit light from the fabric to a surface of the cover. The cover may comprise a plurality of holes configured to direct light from the fabric through the cover. The component may comprise an adhesive layer provided between the fabric and the cover; wherein the adhesive layer is substantially transparent. The cover may comprise at least one of (a) leather, (b) vinyl. The fabric with the optical fibers may comprise at least one of (a) a substantially uniform network of optical fibers woven into a matrix and (b) a network of optical fibers woven into a pattern providing a shape. The shape may comprise a non-uniform shape. The light source may be coupled to the second side of the panel. The component may comprise at least one of (a) an interior trim panel, (b) a door panel, (c) an instrument panel.

The present invention also relates to a component for a vehicle interior providing a passenger compartment configured to be illuminated by a light source providing light. The component may comprise a panel comprising a first side configured to face the passenger compartment and a second side, and a fabric coupled to the light source and the panel comprising optical fibers configured to transmit light provided by the light source within the optical fibers by total internal reflection, wherein the optical fibers are configured to prevent total internal reflection to direct at least a portion of the light provided by the light source substantially perpendicular to the first side of the panel. The component may comprise a cover configured to transmit light from the fabric through the cover. The cover may comprise a plurality of holes configured to direct light from the fabric through the cover. The light source may comprise at least one light emitting diode and the component may comprise at least one of (a) an interior trim panel, (b) a door panel, (c) an instrument panel.

The present invention also relates to a component for a vehicle interior providing a passenger compartment configured to be illuminated by a light source providing light. The component may comprise a panel comprising a first side configured to face the passenger compartment and a second side, and a fabric coupled to the light source and the panel comprising optical fibers configured to transmit light provided by the light source within the optical fibers by total internal reflection, wherein the optical fibers are arranged in the fabric to illuminate a portion of the fabric corresponding to the arrangement of the fibers in the fabric. The optical fibers may be configured to prevent total internal reflection to direct at least a portion of the light provided by the light source substantially perpendicular to the first side of the panel. The fabric may be prepared by a process comprising sandblasting the fabric to prevent total internal reflection in at least a portion of the optical fibers.

### FIGURES

FIG. 1A is a schematic perspective view of a vehicle according to an exemplary embodiment.

FIG. 1B is a schematic perspective cut-away view of a vehicle showing the vehicle interior according to an exemplary embodiment.

FIG. 2A is a schematic perspective view of an interior component for a vehicle according to an exemplary embodiment.

FIG. 2B is a schematic perspective view of an interior component for a vehicle according to an exemplary embodiment.

FIG. 2C is a schematic perspective view of a front side of an interior component for a vehicle according to an exemplary embodiment.

FIG. 2D is a schematic perspective view of a rear side of an interior component for a vehicle according to an exemplary embodiment.

FIG. 2E is a schematic perspective view of an interior component for a vehicle according to an exemplary embodiment.

FIG. 3A is a schematic perspective view of a vehicle door with an illuminating door panel interior component in an off position according to an exemplary embodiment.

FIG. 3B is a schematic perspective view of a vehicle door with an illuminating door panel interior component in an illuminated position according to an exemplary embodiment.

FIG. 3C is schematic front view of an illuminating door panel interior component in an off position according to an exemplary embodiment.

FIG. 3D is a schematic front view of an illuminating door panel interior component in an illuminated position according to an exemplary embodiment.

FIG. 4A is a schematic front view of an interior component for a vehicle according to an exemplary embodiment.

FIG. 4B is a schematic rear view of an interior component for a vehicle according to an exemplary embodiment.

FIG. 4C is a schematic cross-section view of an interior component for a vehicle according to an exemplary embodiment.

FIG. 4D is a schematic cross-section view of an interior component for a vehicle according to an exemplary embodiment.

FIG. 5A is a schematic plan view of a panel insert interior component for a vehicle according to an exemplary embodiment.

FIG. 5B is a schematic cross-section view of an interior component for a vehicle according to an exemplary embodiment.

FIG. 5C is a schematic cross-section view of an interior component for a vehicle according to an exemplary embodiment.

FIG. 5D is a schematic cross-section view of an interior component for a vehicle according to an exemplary embodiment.

FIG. 5E is a schematic cross-section view of an interior component for a vehicle according to an exemplary embodiment.

FIG. 5F is a schematic cross-section view of an interior component for a vehicle according to an exemplary embodiment.

FIG. 5G is a schematic cross-section view of an interior component for a vehicle according to an exemplary embodiment.

FIG. 6 is a schematic cross-section view of an interior component for a vehicle according to an exemplary embodiment.

FIG. 7A is a schematic plan view of a fabric for an interior component of a vehicle according to an exemplary embodiment.

FIG. 7B is a schematic plan view of a fabric for an interior component of a vehicle according to an exemplary embodiment.

FIG. 8A is a schematic perspective view of a door panel with an interior component for a vehicle according to an exemplary embodiment.

FIG. 8B is a schematic enlarged perspective view of a door panel with an interior component for a vehicle according to an exemplary embodiment.

FIG. 9 is a schematic detail view of an interior component for a vehicle according to an exemplary embodiment.

FIG. 10 is a schematic plan view of a door panel interior component for a vehicle according to an exemplary embodiment.

### DESCRIPTION

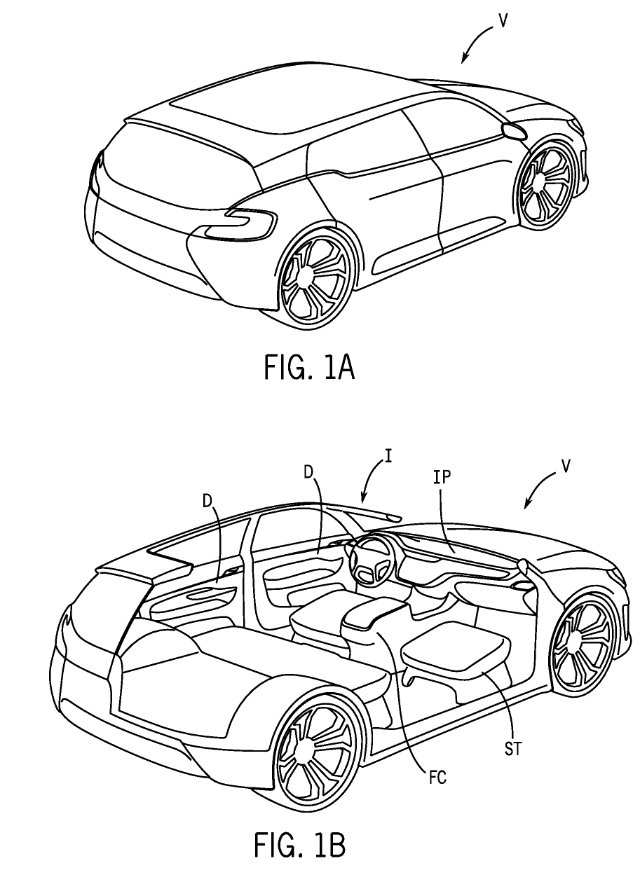

Referring to FIGS. 1A and 1B, a vehicle including an interior I is shown schematically according to an exemplary embodiment. As shown schematically in FIG. 1B, the vehicle interior I may provide a passenger compartment that may include one or more interior components, such as an instrument panel IP, a door panel D, a vehicle seat assembly ST and/or a floor console FC. According to an exemplary embodiment, the interior component can be configured as a molded article having a padded or cushioned portion for the vehicle interior I. According to an exemplary embodiment, the interior component may be configured as a trim part or trim panel for the vehicle interior I. According to an exemplary embodiment, at least a portion of the interior component for the vehicle interior I may be configured to be illuminated by a light source.

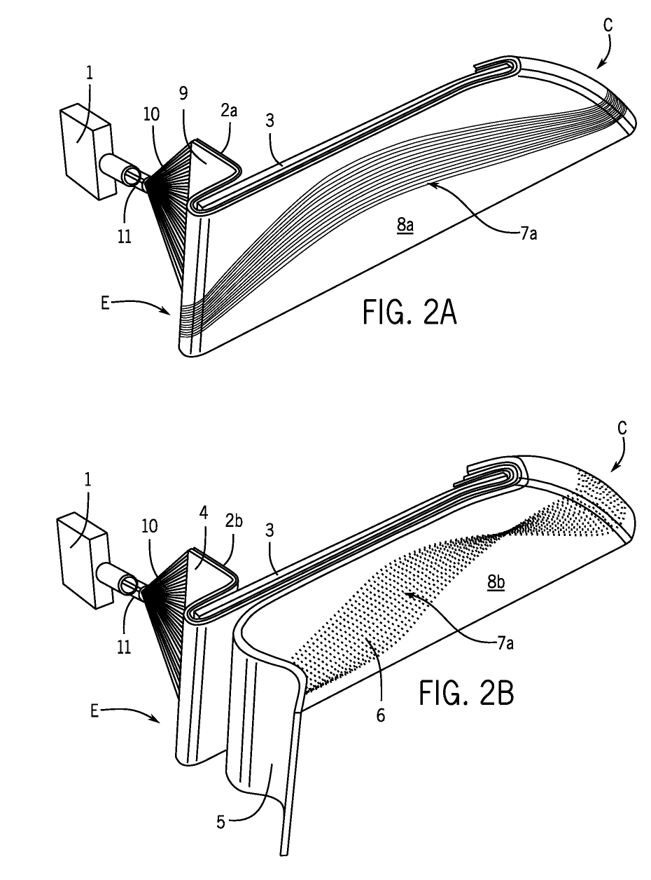

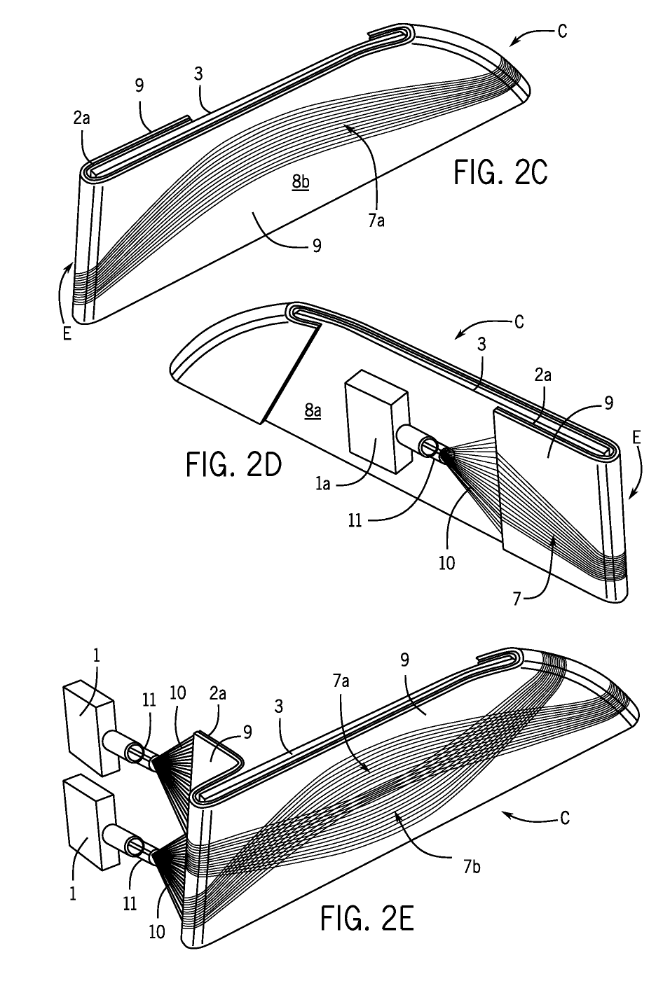

Referring to FIGS. 2A through 2E, an interior component C for a vehicle interior I that may be configured with one or more illuminated portions 7 is shown according to exemplary embodiments. According to an exemplary embodiment, interior component C may be configured as at least one of an interior trim panel, a door panel and an instrument panel. As shown schematically in FIGS. 2A through 2E, interior component C may comprise a panel 3 and a fabric 2a or 2b provided on panel 3. According to an exemplary embodiment, panel 3 may include a first side 8b configured to face the passenger compartment of the vehicle interior I and a second side 8a opposite first side 8b. As shown schematically in FIGS. 2A through 2E, fabric 2a, 2b may be wrapped around at least a portion of each side 8a and 8b of panel 3 and interior compartment C. According to an exemplary embodiment, fabric 2a, 2b may be configured as a light-conducting fabric layer provided on panel 3. According to an exemplary embodiment, fabric 2a or 2b may comprise optical fibers 10 configured to transmit light by total internal reflection.

As shown schematically in FIGS. 2A and 2B, fabric 2a, 2b and optical fibers 10 may provide a portion 7a on first side 8b of interior component C that may provide illumination toward the passenger compartment of the vehicle interior I. According to an exemplary embodiment, fabric 2a, 2b may be configured to provide illumination to portions 7a on first side 8b by providing total internal reflection of optical fibers 10 at all portions of fabric 2a, 2b except illuminated portions 7a. According to an exemplary embodiment, interior component C may be configured to prevent total internal reflection of light along at least a portion of optical fibers 10 provided within fabric 2a, 2b to illuminate interior component C along at least part of first side 8b.

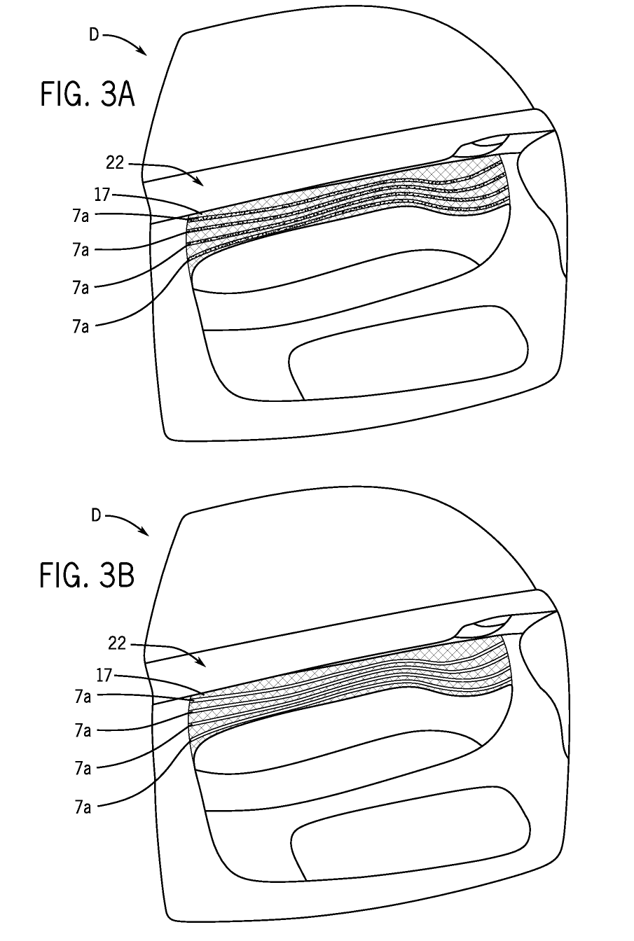

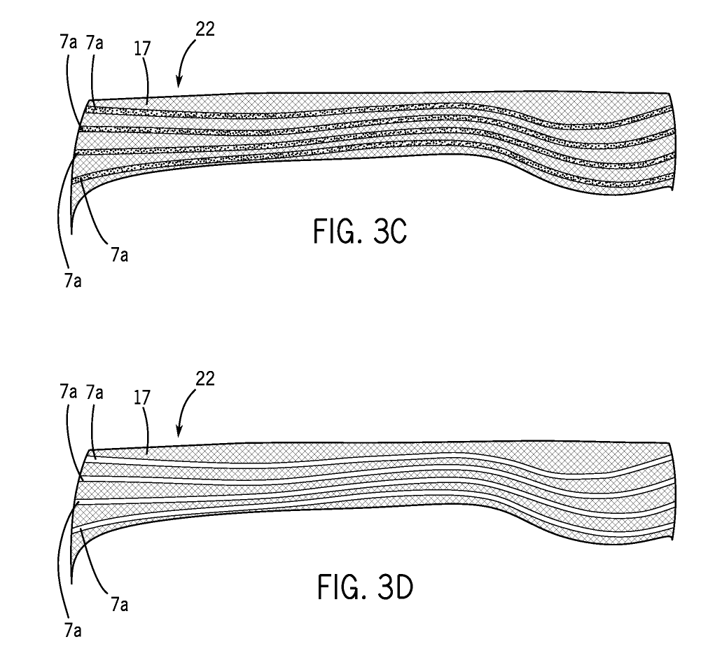

According to an exemplary embodiment, optical fibers 10 may be arranged in fabric 2a, 2b to illuminate a portion 7a of fabric 2a, 2b corresponding to the arrangement of optical fibers 10 in fabric 2a, 2b. As shown schematically in FIGS. 3A through 3D, interior component C (configured as a door or trim panel 22) may include illuminated portions 7a and non-illuminated portions 9. Non-illuminated portions 9 may be configured to correspond to the areas of fabric 2a, 2b not containing optical fibers 10 and/or configured to prevent illumination by total internal reflection. Illuminated portions 7a may be configured to correspond to the arrangement of optical fibers 10 provided in fabric 2a, 2b and be configured to prevent total internal reflection. According to an exemplary embodiment, illuminated portions 7a may be configured to be generally visible when light is transmitted through optical fibers 10 of fabric 2a, 2b. See FIGS. 3A through 3D.

As shown schematically in FIGS. 2A and 2B, a light source 1 may be provided in connection with interior compartment C. According to an exemplary embodiment, light source 1 may be configured to transmit light to interior compartment C through optical fibers 10. According to an exemplary embodiment, light source 1 may comprise at least one light emitting diode. As shown schematically in FIGS. 2A and 2B, optical fibers 10 may be connected to light source 1 by an interface 11. According to an exemplary embodiment, interface 11 may be configured as an optical coupling. According to an exemplary embodiment, optical fibers 10 may be bundled together at the area of interface 11. As shown schematically in FIGS. 2C and 2D, light source 1 may be secured to second side 8a of panel 3 so that light source 1 is not visible from the passenger compartment of the vehicle interior I. As shown schematically in FIG. 2D, optical fibers 10 may be coupled to light source 1 at interface 11 and may extend (with the remainder of fabric 2a) along second side 8a, around edge E and along first side 8b of panel 3 and interior component C. According to an exemplary embodiment as shown schematically in FIG. 2E, multiple light sources 1 may be provided in connection with interior component C. According to an exemplary embodiment, light sources 1 may be configured to provide light of different wavelengths (i.e., different color) to different optical fibers 10 within fabric 2a, 2b.

As shown schematically in FIGS. 2A through 2E, fabric 2a, 2b may at least partially cover second side 8a and first side 8b of panel 3 and interior component C. According to an exemplary embodiment, fabric 2a, 2b may be configured to cover the entire first side 8b of interior component C. As shown schematically in FIGS. 2A through 2D, fabric 2a, 2b may be configured to wrap around an edge E of panel 3 and interior component C between second side 8a and first side 8b. According to an exemplary embodiment, optical fibers 10 of fabric 2a, 2b may be configured to bend around edge E without obstructing the transmission of light from light source 1 through optical fibers 10. According to an exemplary embodiment, optical fibers 10 and fabric 2a, 2b may be constructed from a flexible material allowing optical fibers 10 and fabric 2a, 2b to wrap around edge E and generally conform to first and second sides, 8b and 8a, respectively, of panel 3. According to an exemplary embodiment, optical fibers 10 may be configured to transmit light from light source 1 through fabric 2a, 2b and around edge E of panel 3 and interior component C. As shown schematically in FIGS. 2A through 2C, optical fibers 10 may transmit light from light source 1 through fabric 2a, 2b and illuminate a portion 7a of first side 8b of interior component C.

According to an exemplary embodiment, as shown schematically in FIGS. 2A through 2E, fabric 2a, 2b may be configured to provide total internal reflection of optical fibers 10 except at portions 7a, 7b provided on interior component C. According to an exemplary embodiment, fabric 2a, 2b may be configured to prevent total internal reflection of optical fibers 10 at portions 7a, 7b and allow the light provided by light source 1 and transmitted through optical fibers 10 along fabric 2a, 2b to exit at portions 7a, 7b of first side 8b. As shown schematically in FIGS. 2A through 2E, illuminated portions 7a, 7b of interior component C may be defined by the arrangement of optical fibers 10 in fabric 2a, 2b. According to an exemplary embodiment, portions 7 on first side 8a may be configured into a defined shape or pattern.

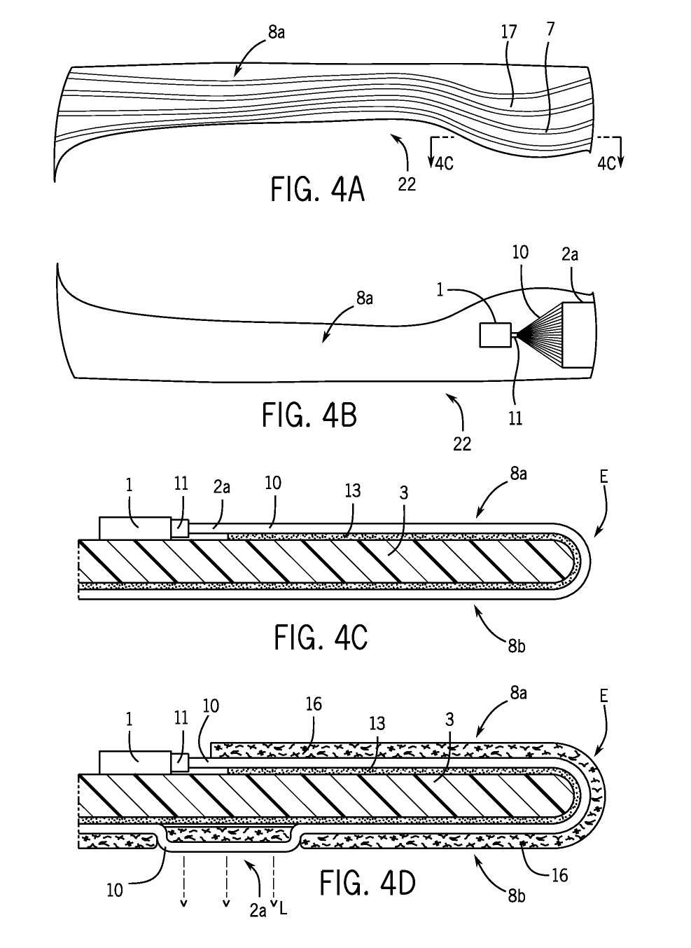

According to an exemplary embodiment, fabric 2a, 2b may comprise a woven or non-woven structure with non-illuminating fibers 16 (e.g., textile fibers) in addition to optical fibers 10. See FIGS. 4D, 7A and 7B. As shown schematically in FIGS. 7A and 7B, the arrangement of optical fibers 10 relative to non-illuminating fibers 16 may provide illuminated portions 7 within fabric 2a, 2b. According to an exemplary embodiment, optical fibers 10 may be woven with textile fibers 16 so that optical fibers 10 are at least partially exposed at portions 7 on first side 8b and optical fibers 10 are covered by textile fibers 16 so that no light may be emitted at other portions (non-illuminated portions) of first side 8b. See FIGS. 4D and 7A.

According to an exemplary embodiment, fabric 2a, 2b may be prepared by a process comprising sandblasting fabric 2a, 2b to prevent total internal reflection in a portion of optical fibers 10. The sandblasting process may be performed to allow light to be emitted from specific portions of optical fibers 10 contained within fabric 2a, 2b. According to an exemplary embodiment, fabric 2a, 2b may be at least partially sandblasted at portions 7 on first side 8b in order to prevent total internal reflection of optical fibers 10 and allow light to be emitted from fabric 2a, 2b at portions 7.

As shown schematically in FIG. 2A, interior component C may include a coating or protective layer 9 provided on fabric 2a. According to an exemplary embodiment, protective layer 9 may comprise a transparent design that protects fabric 2a but does not prevent light from emitting from optical fibers 10, at least at portions 7a on first side 8b.

As shown schematically in FIG. 2B, interior component C may include an intermediate layer 4 secured around fabric 2b. According to an exemplary embodiment, intermediate layer 4 may comprise a transparent material, at least along illuminated portions 7a of fabric 2b. According to an exemplary embodiment, intermediate layer 4 may comprise a reflective material at portions other than illuminated portions 7a.

As also shown schematically in FIG. 2B, interior component C may include a cover 5 provided around fabric 2b (and/or an intermediate layer 4 secured to fabric 2b) along first side 8b of panel 3. According to an exemplary embodiment, cover 5 may comprise a non-transparent material. According to an exemplary embodiment, cover 5 may comprise at least one of leather, or vinyl. According to an exemplary embodiment, cover 5 may be configured to transmit light from fabric 2b to a surface of cover 5. As shown schematically in FIG. 2B, cover 5 may include a plurality of holes, apertures, slits or other openings 6 provided through cover 5. Holes 6 may be configured to direct light from fabric 2b (and optical fibers 10) through cover 5 to the surface interior component C. According to an exemplary embodiment, cover 5 and holes 6 may be configured to prevent total internal reflection of optical fibers 10 at holes 6.

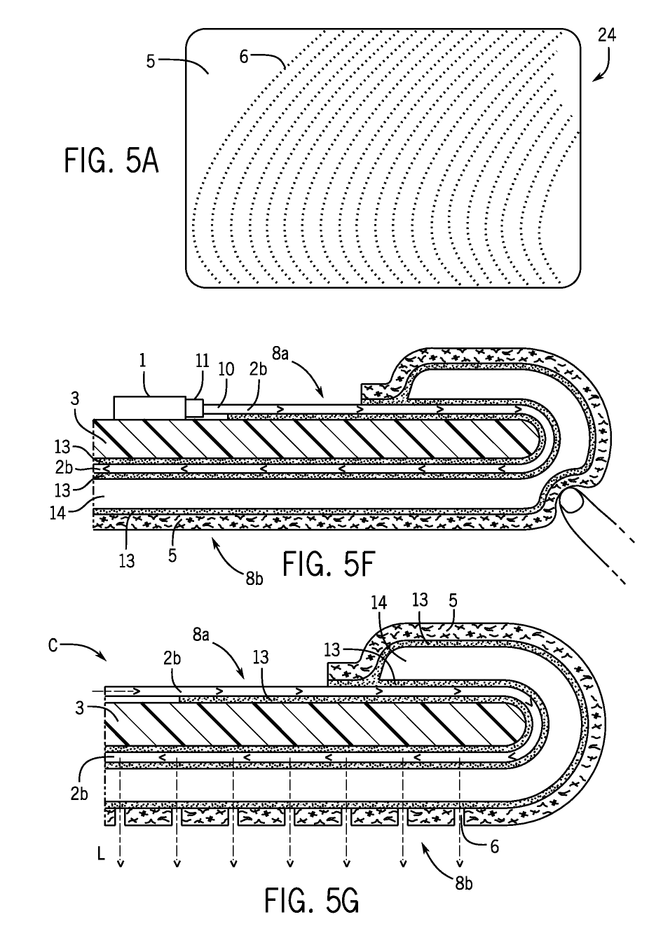

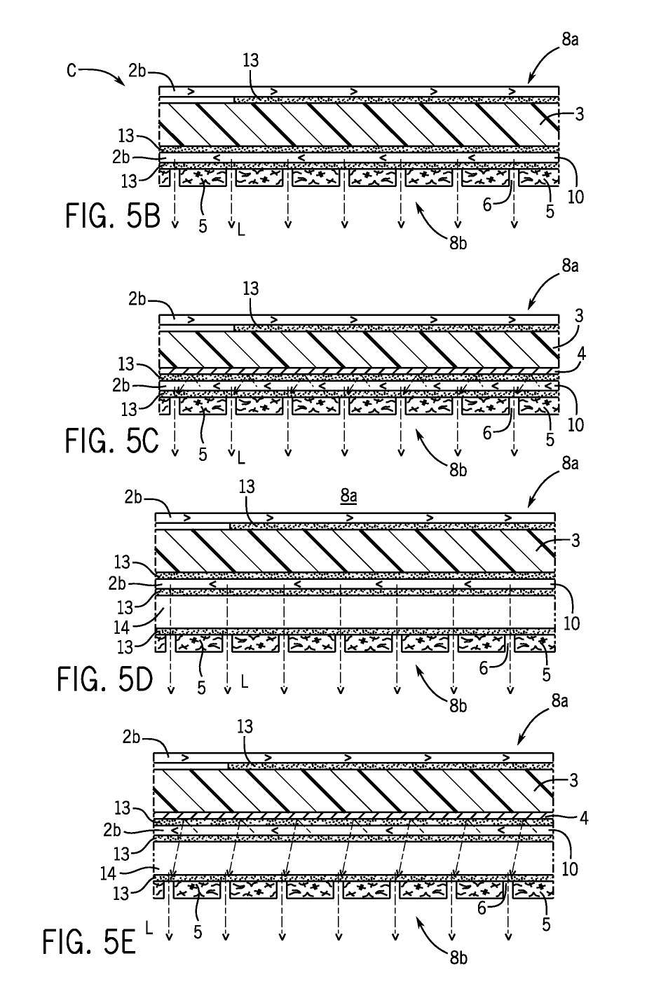

As shown schematically in FIGS. 5C and 5E, interior component C may include a reflective layer 4 provided between panel 3 and fabric 2b. Reflective layer 4 may be configured to reflect light away from first side 8b of panel 3. According to an exemplary embodiment, reflective layer 4 may increase the luminous intensity of light emitted through illuminated portions 7a or 7b of interior compartment C (see FIGS. 2B and 5E) by reflecting light toward holes 6 provided in cover 5.

As shown schematically in FIGS. 5B through 5G, interior component C may include an adhesive layer 13 provided between fabric 2b and cover 5 to secure fabric 2b and cover 5 at least partially together. As shown schematically in FIGS. 5C and 5E, interior component C may include an adhesive layer 13 provided between reflective layer 4 and fabric 2b to secure reflective layer 4 and cover 5 together. According to an exemplary embodiment, as shown schematically in FIGS. 5D and 5E, interior component C may include a spacer 14 provided between fabric layer 2b and cover 5 and secured to fabric layer 2b and cover 5 on each side by an adhesive layer 13. According to an exemplary embodiment, adhesive layer(s) 13 may be substantially transparent.

As shown schematically in FIG. 4D, fabric 2a may be arranged on first side 8b of panel 3 so that selected portions of optical fibers 10 are exposed to the surface of first side 8b. According to an exemplary embodiment, fabric 2a may comprise an integrated or woven structure where optical fibers 10 are interwoven through the remainder of fabric 2b. According to an exemplary embodiment, fabric 2a and optical fibers 10 are arranged so that total internal reflection of light transmitted through optical fibers 10 may occur when optical fibers 10 are located beneath the surface of fabric 2a and total internal reflection of light transmitted through optical fibers 10 may be prevented when optical fibers 10 are located at the surface of fabric 2a.

As shown schematically in FIGS. 7A and 7B, according to an exemplary embodiment, fabric 2a, 2b may comprise textile (non-illuminating) fibers 16 and optical (illuminating) fibers 10. As shown schematically in FIGS. 7A and 7B, fabric 2a, 2b may comprise a network of optical fibers 10 woven into a matrix with textile fibers 16 to form a woven web structure. As shown schematically in FIG. 7B, optical fibers 10 may be woven into a matrix in fabric 2b that is a substantially uniform network. As shown schematically in FIG. 7A, optical fibers 10 may be woven into a pattern providing a shape. According to an exemplary embodiment, optical fibers 10 may be woven into a pattern providing a non-uniform shape.

As shown schematically in FIGS. 5B through 5G, interior component C may comprise a panel 3 having a first side 8b and a second side 8a, a fabric 2b comprising optical fibers 10 provided around panel 3 and secured to panel 3 by an adhesive layer 13, a cover 5 secured to fabric 2b by an adhesive layer 13 along first side 8b of panel 3, and a plurality of openings or holes 6 extending through cover 5 along first side 8b. As shown schematically in FIGS. 5C and 5E, a reflective layer 4 may be provided between panel 3 and fabric 2b and panel 3 along first side 8b of panel 3. As shown schematically in FIGS. 5D through 5G, a spacer layer 14 may be provided between fabric 2b and cover 5 along first side 8b of panel 3. As shown schematically in FIG. 5F, a light source 1 may be provided on second side 8b of panel 3; light source 1 may be coupled to optical fibers 10 at an interface 11 and configured to transmit light through optical fibers 10. According to an exemplary embodiment, fabric 2b may be configured to provide total internal reflection of light transmitted through optical fibers 10 except at portions corresponding to holes 6 provided on first side 8b of the interior component. As shown schematically in FIG. 5B, optical fibers 10 may be configured to prevent total internal reflection at holes 6 to direct at least a portion of the light L provided by light source 1 substantially perpendicular to first side 8b of panel 3. As schematically shown, the light L may be emitted from fabric 2b through holes 6 at a generally perpendicular angle relative to first side 8b of panel 3. As shown schematically in FIGS. 5C and 5E, reflective layer 4 may increase the illumination emitted from holes 6 by directing the light L away from first side 8b of panel 3 and toward holes 6 in cover 5.

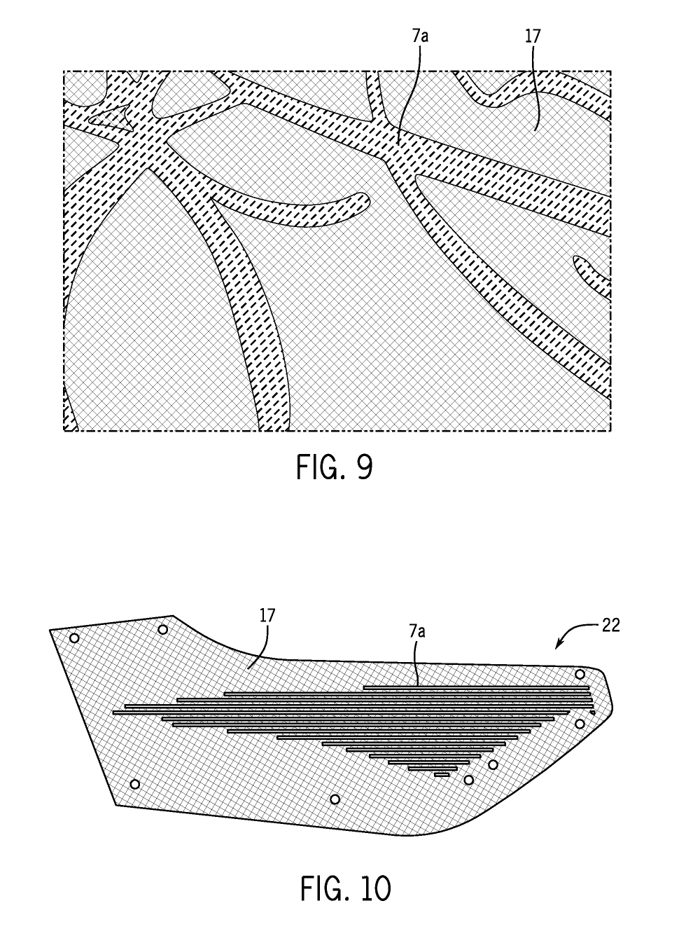

As shown schematically in the various FIGURES, interior component C may be configured to emit light from first side 8b in any number of different patterns, shapes, and/or designs. As shown schematically in FIGS. 2A through 3D, light may be emitted from illuminated portions 7a, 7b (via optical fibers 10 contained within fabric 2a, 2b) in wave-like patterns or overlapping wave patterns. As shown schematically in FIG. 10, the light may be emitted in a generally linear pattern. As shown schematically in FIG. 7B (and in FIGS. 2E and 9), light may be emitted in an interwoven uniform matrix pattern. As shown schematically in FIG. 7A, light may be emitted in a non-uniform shaped pattern or design. In alternative exemplary embodiments, interior component C may be configured to emit light in any number of different patterns, shapes and/or designs.

### Exemplary Embodiment

According to exemplary embodiments, a vehicle interior component (e.g., a door panel D, a door panel insert, a trim part of a dashboard, a trim part of a central console, a floor console FC, or an instrument panel IP) or a component assembly (e.g., a vehicle seat assembly ST) is provided that may be adapted for use in any variety of applications for a vehicle V (e.g., automobile, plane, train).

The vehicle seat assembly ST and the vehicle interior components and/or parts D, IP and FC may be provided in locations throughout the vehicle V other than the location shown in FIGS. 1A and 1B.

According to exemplary embodiments, the interior parts or interior components described in this disclosure may be molded articles having one or more localized or discrete areas or portions of softness or cushioning. According to an exemplary embodiment, the molded articles may be configured as a trim part or trim panel for use in the interior I of a vehicle V (e.g., automobiles such as cars, trucks, buses, and the like; airplanes, boats, etc.).

According to an exemplary embodiment, the interior parts or interior components may be provided with one or more localized or discrete areas or portions of softness or cushioning, which may enable the interior parts or components to selectively include areas of softness in areas that are likely to be interfaced by a passenger or other individual without the need to provide cushioning to the entire trim part. According to an exemplary embodiment, the areas of cushioning may be optimized based on the typical passenger experience.

According to an exemplary embodiment, the interior part or component may be configured to be illuminated by a light source providing light. One advantageous feature of such an interior part or component is that the outer appearance of the interior part or component may be aesthetically improved in a simple, reliable and stable manner.

According to an exemplary embodiment, the interior part or component described in this disclosure may be employed in a variety of applications, and may be generally applicable with any application wherein it would be beneficial to provide a part or component, for example a trim part, having one or more localized or discrete areas or portions, which can be illuminated by means of a backlight. As mentioned above, in exemplary embodiments, the interior component may be a trim, for example, a trim panel, a vehicle seat assembly or any other vehicle interior part for use in a vehicle.

While some of the disclosed exemplary embodiments may be described as a vehicle trim part, such as a door panel, the features of the disclosed embodiments may be equally applicable with other applications such as other panels, molded articles and components and other office, home, or educational, industrial, commercial, or consumer products which employ decorative areas or region, which need to be illuminated.

Referring to FIGS. 2A to 2E, exemplary embodiments of an interior component for a vehicle in accordance with various aspects of the present invention are shown schematically.

The interior components schematically illustrated in FIGS. 2A to 2E may be configured to be illuminated by a light source providing light. According to an exemplary embodiment, the light source is part of a light source arrangement 1.

As schematically shown in FIGS. 2A to 2E, the interior component C may comprise a panel 3 comprising a first side 8b (“A-side”) configured to face the passenger compartment and a second side 8a (“B-side”). According to an exemplary embodiment, a fabric 2a, 2b may be provided comprising optical fibers 10 configured to transmit light provided by the light source within the optical fibers 10 by total internal reflection.

The term “A-side” as used herein may mean the side facing the visible side of the interior trim component. When the interior trim component is installed, the A-side 8b of the interior trim component, or respectively the A-sides of the individual layers forming the interior trim component, thus correspond(s) in each case to the side facing the interior of the vehicle (i.e., the passenger compartment of the vehicle). In contrast thereto, the term “B-side” 8a is to herein indicate the side of a layer or an element of the interior trim component opposite from the A-side 8b.

According to an exemplary embodiment, an interface 11 may be provided that is configured to couple the light source 1 to the fabric 2a, 2b. The interface 11 may comprise of one or more optical couplings in order to couple light from the light source or light source arrangement 1 to the optical fibers 10, which may be arranged as a bundle in the area of the interface 11.

As shown schematically in FIGS. 2A to 2E, the interior component C may be configured so that the fabric 2a, 2b at least partially covers the first side 8b of the panel 3.

According to an exemplary embodiment, the fabric 2a, 2b may be wrapped around at least an edge of the panel 3. According to an exemplary embodiment, at least a portion 7a of the fabric 2a, 2b covering the first side 8b of the panel 3 may be configured to be illuminated by means of the light source or light source arrangement 1.

According to an exemplary embodiment, the panel 3 may comprise a relatively rigid material, such as for example a plastic material, a natural fiber material, metal or mixtures thereof, and may comprise a material not transparent to visible light.

According to an exemplary embodiment, the panel 3 may be made of thermoplastic polyolefin material, homopolymer or copolymer, comprising optionally mineral fillers or reinforcement by glass fibers or natural fibers, or styrenic material, as for example ABS-PC (acrylonitrile-butadiene-styrene and polycarbonate), optionally reinforced by glass fibers. According to an exemplary embodiment, these materials may have a stiffness sufficient to provide a supporting function.

According to an exemplary embodiment, the panel 3 substantially determines a two or three-dimensional form, which may substantially correspond to the form of, for example, an interior trim component to be provided with the illumination function obtained by the inventive components. According to an exemplary embodiment, the panel 3 may exhibit a three-dimensional structure formed by means of, for example, a deep-drawing or injection molding process or another such similar forming process.

According to an exemplary embodiment, the fabric 2a, 2b may be configured as a light-conducting fabric layer, which can be wrapped around at least an edge of the panel 3 such that the fabric 2a, 2b may cover at least partly the first side (A-side) of the panel 3 (i.e., the side of the panel 3 pointing toward in the direction identified by reference numeral 8b in FIGS. 2A to 2C).

According to an exemplary embodiment, the second side 8a (B-side) of the panel 3 is opposite to the first side 8b and may define the backside of the panel 3. As shown schematically in FIGS. 2D and 4B, the second side (B-side) of the panel 3 is identified by reference numeral 8a.

As shown schematically in FIGS. 2A to 2E, the (light-conducting) fabric 2a, 2b can cover the entire A-side 8b of the panel 3; it is however of course also conceivable for the fabric 2a, 2b to only cover parts of the A-side 8b of panel 3.

As shown schematically in FIGS. 2A to 2E, the fabric 2a, 2b may be designed to be flexible such that the fabric 2a, 2b can be wrapped around at least an edge E of the panel 3. According to an exemplary embodiment, the optical fibers 10 of the fabric 2a, 2b may be sized and comprised of a material to allow the optical fibers 10 to bend around the edge E of the panel 3 and transmit light provided by the light source or light source arrangement 1.

According to an exemplary embodiment, the optical fibers 10 may be made of plastic material (particularly PMMA or polycarbonate) and may each have a diameter not greater than 0.3 mm so that the fabric 2a, 2b may be as flexible as possible and can in particular wrap around the edges of the panel 3. This configuration may allow the fabric 2a, 2b to cover the entire side of the panel 3 pointing toward the vehicle interior I such that an attractive visual appearance be achieved and favorable haptics may be provided.

As shown schematically in FIGS. 2A to 2E, the optical fibers 10 of the fabric 2a, 2b may be configured to prevent total internal reflection to direct at least a portion of the light provided by the light source substantially perpendicular to the first side of the panel 3. According to an exemplary embodiment, the optical fibers 10 may be configured to transmit light provided by the light source around the edge of the panel 3.

According to an exemplary embodiment, the light-conducting fabric 2a, 2b may be designed to selectively decouple at least a portion of the coupled light substantially perpendicular to the fabric layer's direction of extension. The term “substantially perpendicular to the fabric layer's direction of extension” as used herein may be understood in that the entire light component does not need to be decoupled from the fabric layer exactly perpendicular to the vertical but rather that a large proportion of the light previously coupled into the fabric layer is decoupled within a specific angular range. According to an exemplary embodiment, the angular range may be, for example 0° to 45° to the surface of the light-conducting fabric layer relative to the vertical.

As shown schematically in FIG. 2A, the optical fibers 10 may be arranged in the fabric 2a, 2b to illuminate a (predefined) portion 7 of the fabric 2a, 2b. According to an exemplary embodiment, this may be achieved by a corresponding arrangement of the fibers 10 in the fabric 2a, 2b.

As shown schematically in FIG. 2A, the fabric 2a may be a woven or nonwoven structure comprising textile fibers 16 (see FIG. 7A) in addition to the optical fibers 10.

As shown schematically in FIG. 7A, the fabric 2a may be composed of fibers 16 made of a textile carrier material and the optical fibers 10. The fibers made of a textile carrier material may be fabricated, for example, from plant fibers, fibers of animal origin, mineral fibers of geological origin, chemical fibers, fibers of synthetic polymers, inorganic chemical fibers, and/or imitation leather.

According to an exemplary embodiment, the optical fibers 10 and the textile fibers 16 are woven or otherwise interrelated with one another such that the optical fibers 10 are partially exposed with respect to the A-side 8b of the fabric 2a.

According to an exemplary embodiment, the areas of the A-side 8b of the fabric 2a, in which the optical fibers 10 are exposed, are predefined and serve as light-emitting areas 7 of the fabric 2a. In the other areas of the A-side 8b of the fabric 2a, the optical fibers 10 may be covered by the textile fibers 16 of the fabric 2a. According to an exemplary embodiment, in these areas, no light may be emitted by the optical fibers 10.

According to an exemplary embodiment as shown schematically in FIGS. 2A and 2B, the optical fibers 10 integrated in the fabric 2a or 2b may be configured to prevent total internal reflection to direct at least a portion of the light provided by the light source substantially perpendicular to the first side (A-side) of the panel 3. According to an exemplary embodiment, the areas 7a, 7b of the A-side of the fabric 2a, 2b, in which the optical fibers 10 are exposed, can be illuminated by means of the light emitted by the light source 1 and coupled in the optical fibers 10 at the interface between the light source 1 and the optical fibers 10.

According to an exemplary embodiment, the fabric 2a, 2b may be at least partially sandblasted in order to prevent total internal reflection in at least a portion of the optical fibers 10. This may allow the optical fibers 10 integrated in the fabric 2a, 2b to be at least partially configured to prevent total internal reflection to direct at least a portion of the light provided by the light source 1 substantially perpendicular to the first side of the panel 3.

Of course, there are also other measures conceivable in order to prevent total internal reflection in at least a portion of the optical fibers 10. For example, any other mechanical and/or chemical treatment of the optical fibers 10 may be used to prevent total internal reflection in at least a portion of the optical fibers 10.

According to an exemplary embodiment, the optical fibers 10 integrated into the fabric 2a, 2b may be sectionally activated so that light-emitting areas 7a, 7b are selectively formed in the fabric 2a, 2b. The optical fibers 10 integrated in the fabric 2a, 2b may be activated by suitably (mechanically or chemically) treating at least the surface of the fabric 2a, 2b facing toward the A-side 8b of the component (e.g., an interior trim component). According to an exemplary embodiment, this treatment generates interference points at least on part of the optical fibers 10 of the fabric 2a, 2b, which may inhibit the TIR condition, such that at least part of the light coupled into the fabric layer can escape again at these points.

According to an exemplary embodiment, the optical fibers 10 of the fabric 2a, 2b can be activated, for example, by sectional sandblasting.

As shown schematically in FIG. 2A, the optical fibers 10 may be selectively activated in certain areas 7a of the fabric 2a in order to thereby produce a specific and predefined pattern.

According to an exemplary embodiment, the optical fibers 10 may be incorporated (e.g., woven or integrated) into the textile fibers 16 of the fabric 2a according to a predefined or pre-definable pattern so that the light-emitting areas 7a of the fabric 2a are predetermined by the position of the optical fibers 10 in the fabric 2a.

According to an exemplary embodiment, a reflective layer (not shown in FIG. 2A) may be at least sectionally provided between the panel 3 and the (light-conducting) fabric 2a in order to reflect light decoupled from the fabric 2a toward the A-side 8b of the interior component C. The reflective layer may be configured to increase the luminous intensity emitted in the direction of the A-side 8b of the interior component C.

As shown schematically in FIG. 5C, the reflective layer may be configured as an intermediate layer 4 provided between the panel 3 and the fabric 2b. This intermediate layer 4 may be at least partly reflective such that light decoupled from the fabric 2b is reflected toward the A-side 8b of the interior component. This can be achieved, for example, by providing the intermediate layer 4 with a metallized layer or with reflective particles so that the intermediate layer 4 serves as a reflective layer.

As shown schematically in FIG. 2A, it may be advantageous for at least a portion of the textile fibers 16 of the fabric 2a to be light-reflecting and substantially opaque to visible light. According to an exemplary embodiment, this can be accomplished, for example, by suitably incorporating pigments into the textile fibers 16 and/or by applying an opaque coating on the textile fibers 16.

As shown schematically in FIG. 2A, in order to optimize the haptics of the interior component and to protect the optical fibers 10 in the fabric 2a from mechanical damage, a coating or protective layer 9 may be provided at least sectionally on the A-side 8b of the fabric 2a. According to an exemplary embodiment, at least a portion of the coating or protective layer 9 may be of transparent design.

As shown schematically in FIG. 2A, a light source arrangement 1 may be used to couple light into the individual optical fibers 10 of the fabric 2a. According to an exemplary embodiment, the light source arrangement 1 may be configured such that light of different wavelengths (colors) can be coupled into predefined or definable areas of the fabric 2a. According to an exemplary embodiment, the light source arrangement 1 may comprise a plurality of preferably separately controllable light sources in order to incorporate light of different wavelengths.

According to an exemplary embodiment, the light source arrangement 1 may be controlled by a control device, and operated as a function of predefined events detected by means of a sensor device associated with the vehicle V in which the component is integrated.

According to an exemplary embodiment, the fabric 2a, 2b may be configured to wrap around the panel 3 and for the light source arrangement 1 to be provided on an area of the interior component behind the panel 3 that is not visible from the outside (i.e., from the A-side of the panel 3) in order to block stray radiation from the light source arrangement 1.

According to an exemplary embodiment, the fabric 2a may be joined to the panel 3 by an adhesive layer (not shown in FIG. 2A). According to an exemplary embodiment, when a coating or protective layer 9 is provided on the A-side of the fabric 2a, the coating or protective layer 9 may be joined to the A-side 8b of the fabric 2a by means of an adhesive layer, whereby the adhesive layer (as well as coating or protective layer 9) may be of at least partially transparent design.

Referring to FIG. 2B, another exemplary embodiment of the interior component C is illustrated.

The structure of the exemplary embodiment illustrated in FIG. 2B may generally correspond to the structure of the exemplary embodiment described above with reference to FIG. 2A; however, according to the exemplary embodiment shown schematically in FIG. 2A, the A-side 8b of the fabric 2b is not directly visible (i.e., the A-side forming the interior component C).

According to the exemplary embodiment shown schematically in FIG. 2B, the A-side 8b of the interior component C may include a surface material layer 5. The surface material layer 5 may be, for example, a plastic film, a layer of imitation leather and/or a layer of leather. According to an exemplary embodiment, the material surface layer 5 may be of a non-transparent design.

According to an exemplary embodiment, the surface material layer 5 may be configured as a cover; the term “surface material layer” and the term “cover” as used herein shall have the same technical meaning. According to an exemplary embodiment, the cover 5 (i.e., surface material layer 5) may comprise at least one of leather and vinyl.

According to an exemplary embodiment, the surface material layer or cover 5 may be configured to transmit light from the fabric 2b to a surface of the surface material layer/cover 5. According to an exemplary embodiment, the surface material layer/cover 5 may comprise a plurality of holes 6 configured to direct light from the fabric 2b through the surface material layer/cover 5.

According to an exemplary embodiment, the component C may comprise an adhesive layer or bond, such as an adhesive bond 13, provided between the fabric 2b and the surface material layer/cover 5 (see FIGS. 5B through 5G).

As shown schematically in FIG. 2B, the surface material layer/cover 5 may be affixed to the A-side 8b of the fabric 2b, or as illustrated in FIG. 2B, to the A-side 8b of an intermediate layer 4 affixed to the A-side 8b of the fabric 2b respectively, by means of an adhesive layer (see FIGS. 5B through 5G).

According to an exemplary embodiment as shown schematically in FIG. 5C, the intermediate layer 4 may serve as a reflective layer in order to reflect light L in the direction of the A-side of the component.

As also shown schematically in FIG. 5C, the intermediate layer 4 may be joined to the light-conducting fabric 2b by means of an adhesive layer 13.

According to an exemplary embodiment, the intermediate layer 4 may be a layer that is at least in part a transparent design where the light emitted from the fabric 2a, 2b may be at least partially sectionally focused.

According to an exemplary embodiment, selected portions of the intermediate layer 4 may be colored so as to sectionally change the color of the light emitted by the interior component.

According to an exemplary embodiment as shown schematically in FIG. 2B, the fabric 2b may include fully activating optical fibers 10.

As shown schematically in FIG. 2B, because holes 6 (e.g., openings, perforations, slits, recesses, etc.) have been introduced into the surface material layer or cover 5, a specific light-emitting pattern may be formed on the A-side 8b of the surface material layer/cover 5, and thus on the A-side 8b of the interior trim component C.

According to an exemplary embodiment, a plurality of recesses, slits and/or holes 6 are formed in the surface material layer 5, through which at least a portion of the light decoupled from the fabric 2b is directed to the A-side 8b of the interior component C.

The recesses, slits and/or holes 6 of the perforation may have a diameter which is small enough so that the holes 6 will not be visually noticeable and/or not visible during the daytime (i.e., when no light is being directed through the holes 6 to the A-side 8b of the interior component C).

According to an exemplary embodiment, the respective recesses, slits and/or holes 6 formed into the surface material layer or cover 5 may have a diameter of 1.2 mm to 1.8 mm. According to an exemplary embodiment, recesses, slits and/or holes 6 may have a diameter of 1.5 mm.

According to an exemplary embodiment, a specific light pattern can be realized on the A-side 8b of the interior component C by the recesses, slits and/or holes 6 of the perforation being incorporated into the surface material layer/cover 5 in a predefined or predefinable pattern.

According to an exemplary embodiment, the number of recesses, slits and/or holes 6 per unit area may be selected according to a predefinable pattern, and may be varied (i.e., the density varied) so that different intensities can be realized.

As shown schematically in FIG. 7B, the fabric 2b utilized, for example, in the embodiment shown schematically in FIG. 2B, may be formed as a woven web structure consisting of optical fibers 10 and textile fibers 16.

As shown schematically in FIGS. 7A and 7B, the textile fibers 16 of the fabric 2a, 2b may be made of a textile carrier material. The fibers 16 made of a textile carrier material may be fabricated, for example, from plant fibers, fibers of animal origin, mineral fibers of geological origin, chemical fibers, fibers of synthetic polymers, inorganic chemical fibers, and/or imitation leather.

According to an exemplary embodiment as shown schematically in FIGS. 2B and 7B (as opposed to the fabric 2a according to the exemplary embodiment shown schematically in FIGS. 2A and 7A), the fabric 2b, all the optical fibers 10 of the fabric 2b, can be activated. This can be due to the fact that, according to the exemplary embodiment shown schematically in FIG. 2B, the surface material layer/cover 5 and the perforation (holes 6) provided in the surface material layer/cover 5 may assume the function of an exit aperture. The exemplary embodiments shown schematically in FIGS. 5B through 5G illustrate this effect in greater detail.

According to an exemplary embodiment, the holes 6 in the surface material layer/cover 5 may be arranged in wave-like patterns or in overlapping wave patterns, as shown schematically in FIG. 2B. Other patterns may also be provided, such as a point-like pattern (snowflake pattern) in alternative exemplary embodiments.

As shown schematically in FIGS. 2C and 2D, the light source arrangement 1 may be rearranged to be fully (visibly) covered by the panel 3 (as opposed to the exemplary embodiment shown schematically in FIG. 2A). As shown schematically in FIGS. 2C and 2D, the light source arrangement 1 may be attached to the B-side 8a of the panel 3.

FIG. 2D is a back view of an exemplary embodiment of the interior component C shown schematically in FIG. 2C. As shown schematically in FIG. 2D, the light source arrangement 1 can be easily arranged on the B-side 8a of the panel 3 such as to be not visible from the A-side of the interior component C.

The exemplary embodiment shown schematically in FIG. 2E mostly corresponds to the exemplary embodiment of FIG. 2A; however, instead of using one (single) light source arrangement 1, the interior component of FIG. 2E is provided with a plurality (e.g., two or more) light source arrangements 1 to independently couple light (including lights of different wavelengths) in dedicated members of the plurality of optical fibers 10. According to an exemplary embodiment, different light emitting areas 7a, 7b can be realized on the A-side 8b of the interior component C.

In this connection, it is to be noted that the term “different light emitting areas” means different areas 7a, 7b on the A-side of the interior component, which can be illuminated independently from each other and, in particular, also with different colors and/or light intensities.

According to an exemplary embodiment, the different light source arrangements 1 may be controlled independently from each other and/or different from each other.

According to an exemplary embodiment, the inventive components as described above may be incorporated into a vehicle door D having a door panel insert 22. Referring to FIG. 3A, a fragmentary view of an exemplary vehicle door D having a door panel insert 22 that is configured as an interior component according to an exemplary embodiment.

As shown schematically in FIG. 3A according to an exemplary embodiment, the light source for the illumination of the door panel insert is switched-off.

As shown schematically in FIG. 3A, in a stage when the light source for the illumination of the door panel insert is switched-off, there may be merely a slight (visibly detectable) difference in the outer appearance between the areas 7a of the door panel insert 22, which can be illuminated, and the areas 17 of the door panel insert 22, which cannot be illuminated.

As shown schematically in FIG. 3B, when the door panel insert 22 is internally illuminated, the contrast between the illuminated areas 7a and the other (non-illuminated) areas 17 on the A-side of the door panel insert 22 is greater (as compared to the exemplary embodiment shown schematically in FIG. 3A.

The difference between areas 7a and areas 17 is also shown schematically in FIGS. 3C and 3D, which respectively show a fragmentary view of the door panel insert 22 of FIG. 3A and FIG. 3B according to an exemplary embodiment.

FIG. 4A shows schematically a fragmentary view of a visible region (A-side) 8b of an interior component (here, a door panel insert 22) according to an exemplary embodiment. From a structural and functional point of view, the exemplary embodiment shown schematically in FIG. 4A mostly corresponds to the exemplary embodiment shown schematically in and described, for example, with reference to FIG. 2A.

As shown schematically in FIG. 4A, the difference in the outer appearance between areas 7 of the door panel insert 22, which can be illuminated, and areas 17 of the door panel insert 22, which cannot be illuminated, is illustrated in greater detail.

In particular, FIG. 4A shows schematically the visible region (A-side) 8b of an interior component 22 having areas 17, where no light is emitted, and areas 7 where light is emitted according to an exemplary embodiment.

FIG. 4B shows schematically a fragmentary view of a non-visible region (B-side) 8a of the interior component shown schematically in FIG. 4A according to an exemplary embodiment.

As shown schematically in FIG. 4B, a light source arrangement 1 can be arranged on the backside 8a of the interior component 22 such as to be invisible from the A-side of the component.

As also shown schematically in FIG. 4B, an interface 11 may be provided that can be configured to couple the light emitted from the light source arrangement 1 to a fabric 2a. The interface 11 may comprise one or more optical couplings in order to couple light from the light source or light source arrangement 1 to optical fibers 10 of the fabric 2a, which may be arranged as a bundle in the area of the interface 11.

According to the embodiment shown schematically in FIGS. 4A to 4D, the fabric 2a may be wrapped around at least an edge E of a panel 3 of the component. This is indicated, in particular in FIGS. 4C and 4D.

According to an exemplary embodiment as shown schematically in FIG. 4A, at least a portion 7 of the fabric 2a covering the first side 8b of the panel 3 may be configured to be illuminated by means of the light source or light source arrangement 1 (see FIG. 4B) on the second side 8a.

FIG. 4C is a schematic sectional view along line 4C-4C in FIG. 4A.

As shown schematically in FIG. 4C, the component may comprise a panel 3, which substantially determines a two or three-dimensional form. As shown schematically in FIG. 4C, a fabric 2a may be provided that may be configured as a light-conducting fabric layer, which can be wrapped around at least an edge E of the panel 3 such that the fabric 2a may cover at least part of the first side 8b (A-side) of the panel 3.

According to an exemplary embodiment, the second side (B-side) of the panel 3 is opposite to the first side and thus defines the backside of the panel 3. As shown schematically in FIG. 4C, the second side (B-side) of the panel 3 is identified by reference numeral 8a.

According to the exemplary embodiment shown schematically in FIG. 4C, the fabric 2a is designed to be flexible such that the fabric 2a can be wrapped around at least an edge E of the panel 3. The optical fibers 10 of the fabric 2a may be sized and comprised of a material to allow the optical fibers to bend around the edge E of the panel 3 and transmit light provided by the light source or light source arrangement 1. According to an exemplary embodiment as shown schematically in FIG. 4C, the fabric 2a is fixed to the panel 3 by means of an adhesive layer or bond 13, such as an adhesive bond provided between the fabric 2a and the panel 3.

FIG. 4D is a schematic sectional view illustrating an exemplary embodiment of an interior component according to a further exemplary embodiment of the present invention.

The exemplary embodiment shown schematically in FIG. 4D generally corresponds to the exemplary embodiment shown schematically in FIG. 4C; however, contrary to the embodiment of FIG. 4C, in the sectional view shown schematically in FIG. 4D, textile fibers 16 cover most of the optical fibers 10 of the fabric 2a, thereby defining areas 17, in which no light can be illuminated from the optical fibers 10 of the fabric 2a.

As shown schematically in FIG. 4D, in at least one area of the A-side 8b of the interior component, the fabric 2a, or at least one of the plurality of optical fibers 10 integrated into the fabric 2a, may be exposed with respect to the A-side 8b of the interior component. This may be achieved, for example, by passing at least one fiber 10 of the plurality of optical fibers 10 integrated into the fabric 2a through the layer defined by the textile fibers 16, which may cover most of the optical fibers 10 of the fabric 2a. According to an exemplary embodiment, the at least one fiber 10 that passes through the layer defined by the textile fibers 16, may define an area 7 as shown schematically in FIG. 4A (i.e., an area 7 of the first side 8b of the panel 3 that is configured to be illuminated by means of the light source or light source arrangement 1).

FIG. 5A is a fragmentary schematic view of a visible region (A-side) of an interior component C (here, insert 24 for an interior trim component) according to another exemplary embodiment of the present invention.

According to the exemplary embodiment shown schematically in FIG. 5A, an outer surface material layer 5 of the interior component 24, which forms the A-side of the interior component 24, may be made of a non-opaque material.

In contrast to the exemplary embodiments shown schematically in FIGS. 4A to 4D, the exemplary embodiment shown schematically in FIG. 5A provides for fully activating the optical fibers 10 of a fabric 2b of the interior component 24. The fabric 2b of the interior component 24 shown schematically in FIG. 5A will be described below in more detail with reference to FIG. 5B to 5G.

As shown schematically in FIGS. 5A through 5E and 5G, a perforation (holes 6) may be introduced into the surface material layer or cover 5 of the interior component 24 to form a specific light-emitting pattern on the A-side of the surface material layer/cover 5, and thus on the A-side 8b of the interior component 24.

As shown schematically in FIG. 5A, a plurality of recesses, slits and/or holes 6 may be formed in the surface material layer 5, through which at least a portion of the light decoupled from the fabric 2b may be directed to the A-side of the interior component 24.

According to an exemplary embodiment, the recesses, slits and/or holes 6 of the perforation may have a diameter that is small enough so that the holes 6 will not be visually noticeable and/or not visible during the daytime (i.e., when no light is being directed through the holes 6 to the A-side of the interior component 24).

According to exemplary embodiments, the respective recesses, slits and/or holes 6 of the perforation may have a diameter of 1.2 mm to 1.8 mm. According to an exemplary embodiment, slits and/or holes 6 of the perforation may have a diameter approximately equal to 1.5 mm.

According to an exemplary embodiment, a specific light pattern can be provided on the A-side of the interior component 24 by forming the recesses, slits and/or holes 6 of the perforation incorporated into the surface material layer/cover 5 in a predefined or predefinable pattern.

As shown schematically in FIG. 7B, the fabric 2b utilized, for example, in the embodiment shown schematically in FIGS. 5A to 5G, may be formed as a woven web structure comprising optical fibers 10 and textile fibers 16. The textile fibers 16 of the fabric 2b shown schematically in FIG. 7B may be made of a textile carrier material. The fibers made of a textile carrier material may be fabricated, for example, from plant fibers, fibers of animal origin, mineral fibers of geological origin, chemical fibers, fibers of synthetic polymers, inorganic chemical fiber, and/or imitation leather.

In the exemplary embodiments of the interior component C shown schematically in FIGS. 5B to 5G, all the optical fibers 10 of the fabric 2b may be activated. In the exemplary embodiments shown schematically in FIGS. 5B to 5G, a surface material layer/cover 5 and particularly a perforation provided in the surface material layer/cover 5 may assume the function of an exit aperture. This is shown schematically by the arrows indicated by the reference numeral L in FIGS. 5B, 5C, 5D, 5E, and 5G.

According to an exemplary embodiment, the holes 6 in the surface material layer/cover 5 are arranged in wave-like patterns or in overlapping wave patterns, as shown schematically in FIG. 5A. Other patterns may also be provided, such as a point-like pattern (e.g., a snowflake pattern) is in exemplary embodiments.

FIG. 5B is a schematic sectional view of a part of an interior component C according to an exemplary embodiment of the present invention, wherein an outer surface material layer 5 of the interior component that forms the A-side 8b of the interior component, may be made of a non-opaque material.

The interior component C shown schematically in FIG. 5B may generally correspond to the interior component shown schematically in FIG. 2B.

As shown schematically in FIG. 5B, the A-side 8b of the interior component C may be formed by a surface material layer 5. The surface material layer 5 may comprise, for example, a plastic film, a layer of imitation leather or also a layer of leather which on the whole may be of non-transparent design.

In accordance with the exemplary embodiments disclosed herein, the surface material layer 5 may function as a cover. The cover (surface material layer 5) may comprise at least one of leather and vinyl.

According to an exemplary embodiment, the surface material layer 5 may serve as a cover. Accordingly, the term “surface material layer” and the term “cover” as used herein may have the same technical meaning.

As shown schematically in FIG. 5B, the surface material layer or cover 5 may be configured to transmit light L from the fabric 2b to a surface of the surface material layer/cover 5. According to an exemplary embodiment, the surface material layer/cover 5 may comprise a plurality of holes 6 configured to direct light L from the fabric 2b through the surface material layer/cover 5.

As shown schematically in FIG. 5B, the component C may comprise an adhesive layer or bond 13, such as an adhesive bond, provided between the fabric 2b and the surface material layer/cover 5. An adhesive bond 13 may also be provided between the fabric 2b and the panel 3 of the interior component.

According to an exemplary embodiment, a plurality of holes 6 may be formed in the surface material layer 5, through which at least a portion of the light L decoupled from the fabric 2b may be directed to the A-side 8b of the interior component C.

According to an exemplary embodiment, the holes 6 of the perforation may have a diameter that is small enough so that the holes 6 will not be visually noticeable and/or not visible during the daytime (i.e., when no light is being directed through the holes 6 to the A-side 8b of the interior component).

Although not shown schematically in FIG. 5B, the interior component C may also be provided with a light source arrangement 1 for coupling light L in the optical fibers 10 of the fabric 2b. The light source arrangement 1 may be provided on the B-side 8a of the interior component.

FIG. 5C is a schematic sectional view of a part of an interior component C according to another exemplary embodiment, wherein an outer surface material layer 5 of the interior component C, which forms the A-side 8b of the interior component C, may be made of a non-opaque material.

The interior component C shown schematically in FIG. 5C may generally correspond to the interior component C shown schematically in FIG. 5B; however, in the exemplary embodiment illustrated in FIG. 5C, an intermediate layer 4 may be joined to the A-side 8b of the panel 3 an adhesive layer 13. The intermediate layer 4 may be a layer of at least in part reflective design, with which the light emitted from the fabric 2b may be at least sectionally focused.

FIG. 5D is a schematic sectional view of a part of an interior component C according to another exemplary embodiment, wherein an outer surface material layer 5 of the interior component C, which forms the A-side 8b of the interior component C, may be made of a non-opaque material.

The interior component C shown schematically in FIG. 5D may generally correspond to the interior component C shown schematically in FIG. 5B; however, in the exemplary embodiment illustrated in FIG. 5D, a spacer/foam layer 14 is provided between the fabric 2b and the surface material layer/cover 5 that may optimize the haptics of the interior component. According to an exemplary embodiment, the spacer/foam layer 14 may be at least partly translucent.

As shown schematically in FIG. 5D, the spacer/foam layer 14 may be fixed to the fabric 2b and the surface material layer/cover 5 by an adhesive 13 provided between the spacer/foam layer 14 and the fabric 2b on one side, and by an adhesive 13 provided between the spacer/foam layer 14 and the surface material layer/cover 5 on the other side.

FIG. 5E is a schematic sectional view of a part of an interior component C according to another exemplary embodiment of the present invention. This exemplary embodiment may generally correspond to a combination of the exemplary embodiments shown schematically in FIGS. 5C and 5D.

As shown schematically in FIG. 5E, an intermediate layer 4 may be provided between the panel 3 of the interior component C and the fabric 2b. The intermediate layer 4 may be joined to the panel 3 and the fabric 2b by means of adhesive layers 13. The intermediate layer 4 may be a layer of at least in part reflective design, with which the light emitted from the fabric 2b may be at least sectionally focused.

FIGS. 5F and 5G are schematic sectional views of a part of an interior component C according to another exemplary embodiment of the present invention, wherein an outer surface material layer of the interior component, which forms the A-side 8b of the interior component C, may be made of a non-opaque material.

The exemplary embodiment shown schematically in FIG. 5F may generally correspond to the exemplary embodiment shown schematically in FIG. 5D; however, in FIG. 5F, a section of the interior component C is shown where the surface material layer 5 of the interior component C is not provided with any hole 6 thereby blocking light from back-illuminating the A-side 8b of the interior component in this section.

The exemplary embodiment shown schematically in FIG. 5F further shows the arrangement of the light source arrangement 1 on the B-side 8a of the interior component C. Light emitted from the light source arrangement 1 may be coupled to the optical fibers 10 of the fabric 2b and then guided (via a corner of the interior component) to the A-side area 8b of the component C.

As shown schematically in FIG. 5F, the spacer/foam layer 14 and the surface material layer 5 may not cover the entire B-side 8a of the interior component C. Rather, these layers 14, 5 may be interrupted and fixed (by means of an adhesive 13) to the fabric 2b at the B-side of the interior component C.

The exemplary embodiment of FIG. 5G may generally correspond to the exemplary embodiment of FIG. 5F; however, according to the exemplary embodiment shown schematically in FIG. 5G, no light source arrangement 1 is shown.

As shown schematically in FIG. 5G, the surface material layer 5 of the interior component C may be provided with holes 6. According to an exemplary embodiment, a plurality of holes 6 may be formed in the surface material layer 5, through which at least a portion of the light L decoupled from the fabric 2b may be directed to the A-side 8b of the interior component C.

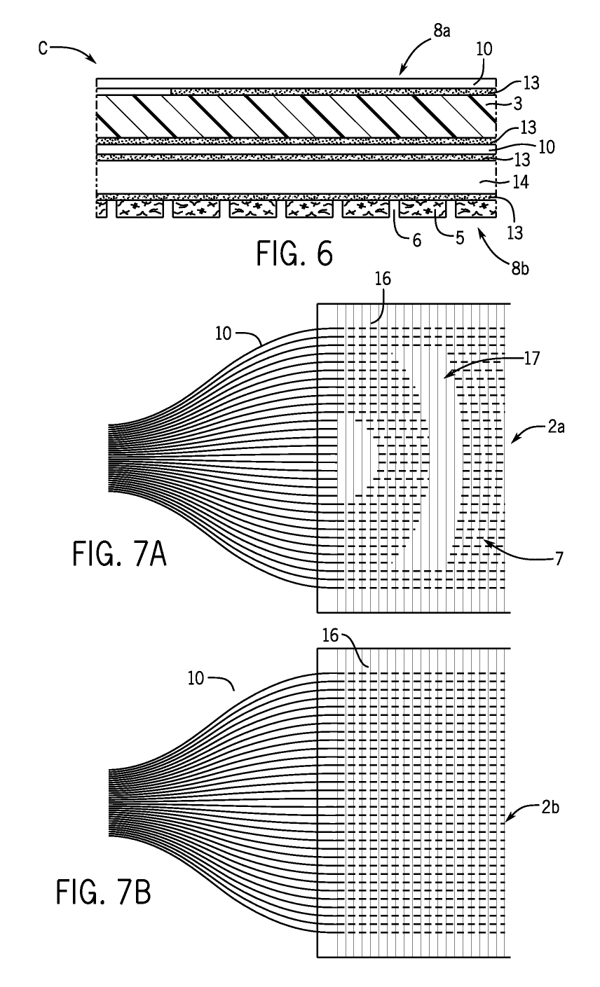

FIG. 6 is a schematic sectional view of a part of another interior component C according to an exemplary embodiment. As shown schematically in FIG. 6, the A-side 8b of the interior component C may be formed by a surface material layer 5. The surface material layer 5 may comprise, for example, a plastic film, a layer of imitation leather or also a layer of leather which on the whole is preferably of non-transparent design. According to an exemplary embodiment, the surface material layer 5 may function as a cover. The cover (surface material layer 5) may comprise at least one of leather and vinyl.

As shown schematically in FIG. 6, the surface material layer or cover may be configured to transmit light from a fabric 2 to a surface of the surface material layer/cover 5. According to an exemplary embodiment, the surface material layer/cover 5 may comprise a plurality of holes 6 configured to direct light from the fabric 2 through the surface material layer/cover 5.

As shown schematically in FIG. 6, the component C may further comprise an adhesive layer or bond 13, such as an adhesive bond, provided between the fabric 2 and the surface material layer/cover 5. According to an exemplary embodiment, an adhesive bond 13 may also be provided between the fabric 2 and a panel 3 of the interior component C.

Although not shown schematically in FIG. 6, the interior component C may be provided with a light source arrangement for coupling light in optical fibers of the fabric 2. The light source arrangement may be provided on the B-side 8a of the interior component C.

As shown schematically in FIG. 6, a spacer/foam layer 14 may be provided between the fabric 2 and the surface material layer/cover 5 that may optimize the haptics of the interior component C. According to an exemplary embodiment, the spacer/foam layer 14 may be at least partly translucent. The spacer/foam layer 14 may be fixed to the fabric 2 and the surface material layer/cover 5 by means of an adhesive 13 provided between the spacer/foam layer 14 and the fabric 2 on one side, and by means of an adhesive 13 provided between the spacer/foam layer 14 and the surface material layer/cover 5 on the other side.

Although not illustrated in FIG. 6, according to an exemplary embodiment, the interior component C may be provided with an intermediate or reflective layer, which can be joined to the A-side 8b of the panel 3 by means of an adhesive layer. According to an exemplary embodiment, the intermediate layer may be a layer of at least in part reflective design, with which the light emitted from the fabric 2 may be at least sectionally focused.

FIG. 7A is a schematic plan view of a section of a fabric layer for use in interior components according to exemplary embodiments of the present invention, wherein a plurality of optical fibers 10 may be integrated into the fabric 2a such that the fabric 2a comprises regions with exposed sections of the optical fibers 10 and regions with concealed sections of the optical fibers 10. The fabric layer 2a may be, for example, applicable in the exemplary embodiment illustrated in FIG. 2A.

As shown schematically in FIG. 7A, the fabric 2a may be composed of fibers 16 made of a textile carrier material and the optical fibers 10. The fibers made of a textile carrier material may be fabricated, for example, from plant fibers, fibers of animal origin, mineral fibers of geological origin, chemical fibers, fibers of synthetic polymers, inorganic chemical fibers, and/or imitation leather.

According to an exemplary embodiment, the optical fibers 10 and the textile fibers 16 may be preferably woven or otherwise interrelated with one another such that the optical fibers 10 are partially exposed with respect to the A-side of the fabric 2a.

According to an exemplary embodiment, the areas of the A-side of the fabric 2a, in which the optical fibers 10 are exposed, may be predefined and serve as light-emitting areas of the fabric 2a. According to an exemplary embodiment, in the other areas of the A-side of the fabric 2a, the optical fibers 10 may be covered by the textile fibers 16 of the fabric 2a. Accordingly, in these areas, no light can be emitted by the optical fibers 10.

FIG. 7B is a schematic plan view of a section of a fabric layer 2b for use in interior components according to exemplary embodiments of the present invention, wherein a plurality of optical fibers 10 may form a textile-like layer. The fabric layer 2b may be, for example, applicable in the exemplary embodiment illustrated in FIG. 2B.

As shown schematically in FIG. 7B, the fabric 2b may be formed as a woven web structure comprising optical fibers 10 and textile fibers 16. The textile fibers 16 of the fabric 2b shown schematically in FIG. 7B may be made of a textile carrier material. The fibers made of a textile carrier material may be fabricated, for example, from plant fibers, fibers of animal origin, mineral fibers of geological origin, chemical fibers, fibers of synthetic polymers, inorganic chemical fibers, and/or imitation leather.

Contrary to the fabric 2a illustrated in FIG. 7A and utilized, for example, in the exemplary embodiment of FIG. 2A, in the exemplary embodiment of the fabric 2b illustrated in FIG. 7B, all of the optical fibers 10 of the fabric 2b may be activated.

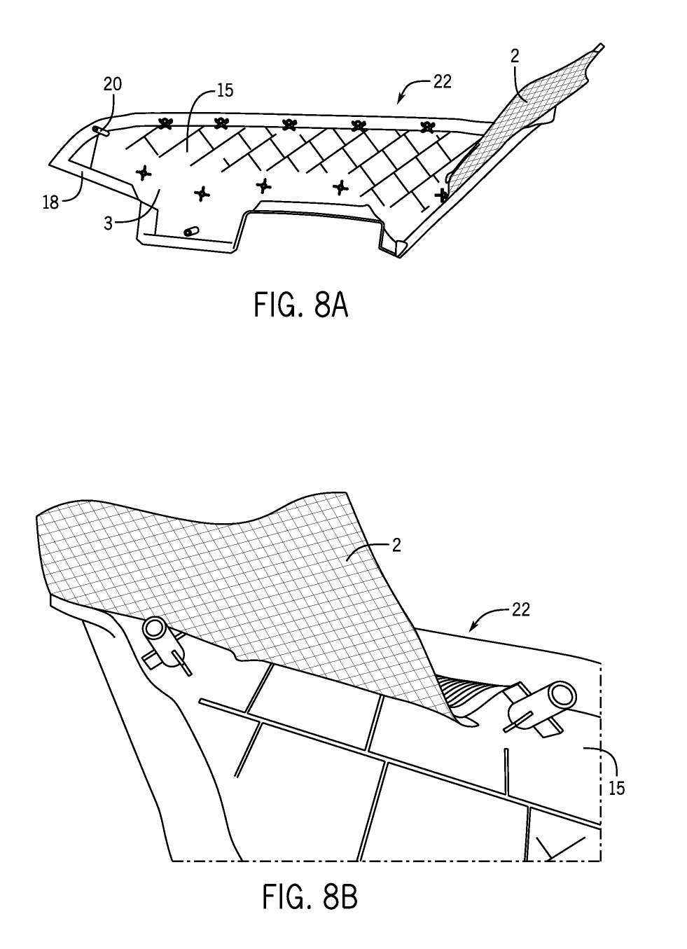

FIG. 8A is a schematic view of a reverse side of a door or instrument panel insert 22 provided with an interior component 2 according to an exemplary embodiment of the present invention. As shown schematically in FIG. 8A, the instrument panel insert 22 may be provided with a plurality of fastening means and stand offs 20 for fixing the instrument panel insert 22.

FIG. 8B is another schematic perspective view of a part of the door or instrument panel insert 22 according to FIG. 8A. As shown schematically in FIGS. 8A and 8B, the fabric of the component for illuminating the A-side of the door or instrument panel insert 22 may be wound around a corner or flap 18 of the door or instrument panel insert 22, such that a control unit of the component and/or a light source arrangement of the component (both not illustrated in FIGS. 8A and 8B can be provided at the B-side 3 of the door or instrument panel insert 22.

In FIGS. 8A and 8B, the reference numeral 15 indicates a vehicle door. According to an exemplary embodiment, the door panel insert 22 may be attached to the vehicle door 15.

FIG. 9 is an enlarged view of the front side (A-side) of an interior component 2 according to an exemplary embodiment.

According to an exemplary embodiment as shown schematically in FIG. 9, the front side (A-side) of an interior component 2 may comprise areas 7a, which can be illuminated, and areas 17, which cannot be illuminated.

According to an exemplary embodiment, the areas 7a may correspond to the areas of the A-side of a fabric 2a, in which optical fibers 10 may be exposed (see FIG. 7A). The areas may be predefined and serve as light-emitting areas of the fabric 2a. In the other areas of the A-side of the fabric 2a, the optical fibers 10 may be covered, in particular, by textile fibers 16 of the fabric 2a. According to an exemplary embodiment, in these areas, no light can be emitted by the optical fibers 10. Hence, these areas correspond to the areas indicated by reference numeral 17 in FIG. 9.

FIG. 10 is a schematic plan view of a door panel insert 22 configured as an interior component according to an exemplary embodiment. As shown schematically in FIG. 10, the front side (A-side) of an interior component 22 may comprise areas 7a, which can be illuminated, and areas 17, which cannot be illuminated. The areas 7a may correspond to the areas of the A-side of a fabric 2a, in which optical fibers 10 are exposed (see FIG. 7A). These areas may be predefined and serve as light-emitting areas of the fabric 2a. In the other areas of the A-side of the fabric 2a, the optical fibers 10 may be covered, in particular, by textile fibers 16 of the fabric 2a. Accordingly, in these areas, no light can be emitted by the optical fibers 10. Hence, these areas correspond to the areas indicated by reference numeral 17 in FIG. 10.

The invention is not limited to the embodiments of the inventive interior trim component depicted in the drawings but rather yields from a synopsis of all the features disclosed herein together.

The embodiments described and illustrated in the figures are presented by way of example only and are not intended as a limitation upon the concepts and principles of the present invention. As such, it will be appreciated by one having ordinary skill in the art that various changes in the elements and their configuration and arrangement are possible without departing from the spirit and scope of the present invention as set forth in the appended claims.

It is important to note that the construction and arrangement of the elements of the inventive concepts and inventions as described in this application and as shown schematically in the figures above is illustrative only. Although some embodiments of the present inventions have been described in detail in this disclosure, those skilled in the art who review this disclosure will readily appreciate that many modifications are possible without materially departing from the novel teachings and advantages of the subject matter recited. All such modifications are intended to be included within the scope of the present inventions. Other substitutions, modifications, changes and omissions may be made in the design, operating conditions and arrangement of the preferred and other exemplary embodiments without departing from the spirit of the present inventions.

It is important to note that the apparatus of the present inventions can comprise conventional technology (e.g. as implemented in present configuration) or any other applicable technology (present or future) that has the capability to perform the functions and processes/operations indicated in the FIGURES. All such technology is considered to be within the scope of the present inventions and application.

1. A component for a vehicle interior providing a passenger compartment configured to be illuminated by a light source providing light comprising:
(a) a panel comprising a first side configured to face the passenger compartment and a second side;
(b) a fabric comprising optical fibers configured to transmit light provided by the light source within the optical fibers by total internal reflection;
(c) an interface configured to couple the light source to the fabric;
wherein the fabric at least partially covers the first side of the panel;
wherein the fabric is wrapped around at least an edge of the panel; and
wherein at least a portion of the fabric covering the first side is configured to be illuminated.

2. The component of claim 1 wherein the optical fibers are configured to prevent total internal reflection to direct at least a portion of the light provided by the light source substantially perpendicular to the first side of the panel.

3. The component of claim 1 wherein the optical fibers are configured to transmit light provided by the light source around the edge of the panel.

4. The component of claim 1 wherein the optical fibers are sized and comprised of a material to allow the optical fibers to bend around the edge of the panel and transmit light provided by the light source.

5. The component of claim 1 further comprising a reflective layer provided between the panel and the fabric; wherein the reflective layer is configured to reflect light away from the first side of the panel.

6. The component of claim 1 further comprising a cover configured to transmit light from the fabric to a surface of the cover.

7. The component of claim 6 wherein the cover comprises a plurality of holes configured to direct light from the fabric through the cover.

8. The component of claim 6 further comprising an adhesive layer provided between the fabric and the cover; wherein the adhesive layer is substantially transparent.

9. The component of claim 6 wherein the cover comprises at least one of (a) leather, (b) vinyl.

10. The component of claim 1 wherein the fabric with the optical fibers comprises at least one of (a) a substantially uniform network of optical fibers woven into a matrix and (b) a network of optical fibers woven into a pattern providing a shape.

11. The component of claim 10 wherein the shape comprises a non-uniform shape.

12. The component of claim 1 wherein the light source is coupled to the second side of the panel.

13. The component of claim 1 wherein the component comprises at least one of (a) an interior trim panel, (b) a door panel, (c) an instrument panel.

14. A component for a vehicle interior providing a passenger compartment configured to be illuminated by a light source providing light comprising:
(a) a panel comprising a first side configured to face the passenger compartment and a second side;
(b) a fabric coupled to the light source and the panel comprising optical fibers configured to transmit light provided by the light source within the optical fibers by total internal reflection;
wherein the optical fibers are configured to prevent total internal reflection to direct at least a portion of the light provided by the light source substantially perpendicular to the first side of the panel.

15. The component of claim 14 further comprising a cover configured to transmit light from the fabric through the cover.

16. The component of claim 15 wherein the cover comprises a plurality of holes configured to direct light from the fabric through the cover.

17. The component of claim 14 wherein the light source comprises at least one light emitting diode and the component comprises at least one of (a) an interior trim panel, (b) a door panel, (c) an instrument panel.

18. A component for a vehicle interior providing a passenger compartment configured to be illuminated by a light source providing light comprising:
(a) a panel comprising a first side configured to face the passenger compartment and a second side;
(b) a fabric coupled to the light source and the panel comprising optical fibers configured to transmit light provided by the light source within the optical fibers by total internal reflection;
wherein the optical fibers are arranged in the fabric to illuminate a portion of the fabric corresponding to the arrangement of the fibers in the fabric.

19. The component of claim 18 wherein the optical fibers are configured to prevent total internal reflection to direct at least a portion of the light provided by the light source substantially perpendicular to the first side of the panel.

20. The component of claim 18 wherein the fabric is prepared by a process comprising sandblasting the fabric to prevent total internal reflection in at least a portion of the optical fibers.
